(19) United States
(12) Patent Application Publication
(10) Pub. No.: US 2025/0258493 A1
(43) Pub. Date: Aug. 14, 2025

(54) Proxy Processor Based Monitoring of Control System Processor Operational State

(71) Applicant: Disney Enterprises, Inc., Burbank, CA (US)

(72) Inventors: Brian F. Walters, Groveland, FL (US); Brian Feeny, Winter Garden, FL (US); Christopher C. Hofer, Ocoee, FL (US); Jose L. Corpuz, Ocoee, FL (US); Nicholas Stantzos, Winter Garden, FL (US)

(21) Appl. No.: 18/439,152

(22) Filed: Feb. 12, 2024

(51) Int. Cl. G05B 23/02; G05B 19/05

(52) U.S. Cl. CPC G05B 23/0262; G05B 19/058; G05B 23/027

(57) ABSTRACT

A system includes an operating apparatus, a control system processor configured to control the operating apparatus by dynamically providing control data to the operating apparatus, the control system processor being further configured to dynamically receive status data from the operating apparatus, wherein an operational state of the control system processor is defined in accordance with the status data received from the operating apparatus. The system also includes a data acquisition module configured to also dynamically receive the status data from the operating apparatus, as well as a proxy processor communicatively coupled to the data acquisition module. The proxy processor is configured to obtain the status data from the data acquisition module, and mimic, using the status data obtained from the data acquisition module, the operational state of the control system processor.

### BACKGROUND

In various commercial and industrial applications, it may be important for control systems engineers to monitor the operational state of one or more control system processors of a system or machine, in order to analyze the performance of the control system processor or processors, as well as the system or machine being controlled. Such monitoring can advantageously enable the timely identification of needed corrective maintenance and/or software improvements and may substantially reduce or eliminate downtime of the system or machine.

Nevertheless, in some applications, reliability, safety, or security concerns may result in direct access to control system processors being heavily restricted or prohibited entirely. Thus, in the interests of operational efficiency, there is a need in the art for a solution that provides systems engineers with the ability to monitor the operational state of a control system processor, indirectly and in real-time, while concurrently isolating the control system processor from direct testing.

### BRIEF DESCRIPTION OF THE DRAWINGS

FIG. 1 shows an exemplary system for performing proxy processor based monitoring of control system processor operational state, according to one implementation;

FIG. 2 shows a flowchart presenting an exemplary method for performing proxy processor based monitoring of control system processor operational state, according to one implementation;

FIG. 3 shows an exemplary system for performing proxy processor based monitoring of control system processor operational state, according to another implementation; and

FIG. 4 shows a flowchart describing additional actions for extending the method presented by the flowchart in FIG. 2, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

The present application discloses systems and methods for performing proxy processor based monitoring of control system processor operational state that address and overcome deficiencies in the conventional art. Moreover, in some implementations, the present solution for performing proxy processor based monitoring of control system processor operational state may advantageously be implemented as automated systems and method.

As used in the present application, the terms “automation,” “automated” and “automating” refer to systems and processes that do not require the participation of a human control systems engineer. Although in some implementations the proxy processor based control system processor monitoring solution disclosed herein may be periodically reviewed or supervised by a control systems engineer, that human participation is optional. Thus, the methods described in the present application may be performed under the control of hardware processing components of the disclosed systems.

By way of overview, and as noted above, in various commercial and industrial applications, it may be important for control systems engineers to monitor the operational state of one or more control system processors of a system or machine (hereinafter “operating apparatus, in order to analyze the performance of the control system processor or processors, as well as that of the operating apparatus being controlled. Such monitoring can advantageously enable the timely identification of needed corrective maintenance and/or software improvements and may substantially reduce or eliminate downtime of the operating apparatus.

Nevertheless, in some applications, any combination of reliability, safety, and security concerns may result in direct access to control system processors being heavily restricted or prohibited entirely. Thus, the present application discloses a solution that provides systems engineers with the ability to monitor the operational state of a control system processor, indirectly and in real-time, via a proxy processor configured to mimic the operational state of the control system processor, while concurrently isolating the control system processor from direct testing. It is noted that, as defined for the purposes of the present application, the expression real-time refers to synchronization between the proxy processor and the control system processor, thereby enabling monitoring the present operational state of the control system processor.

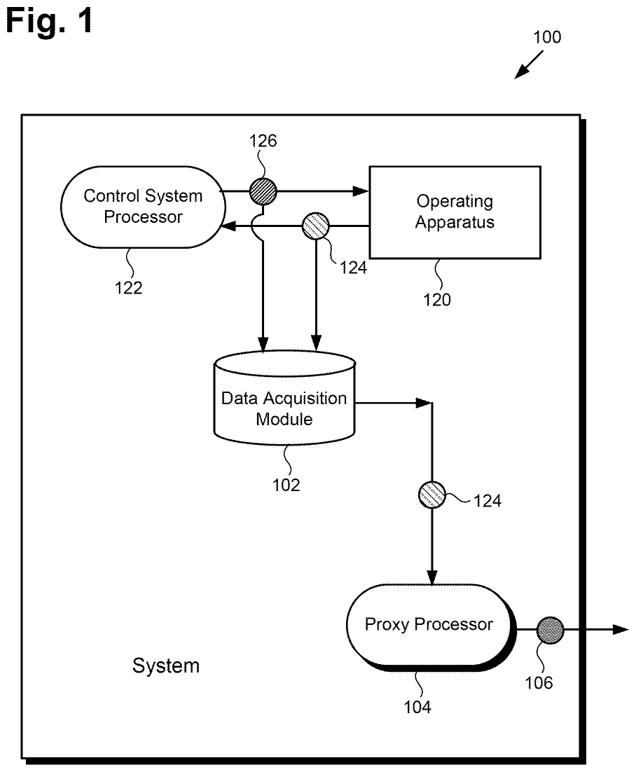

FIG. 1 shows exemplary system 100 for performing proxy processor based monitoring of control system processor operational state, according to one implementation. System 100 includes operating apparatus 120 and control system processor 122 controlling operating apparatus 120 by dynamically providing control data 126 to operating apparatus 120. It is noted that control system processor 122 also dynamically receives status data 124 from operating apparatus 120. It is further noted that the operational state of control system processor 122 is defined in accordance with status data 124 received from operating apparatus 120.

As shown in FIG. 1, system 100 further includes data acquisition module 102 implemented as a non-transitory storage medium. According to the present exemplary implementation, data acquisition module 102 also dynamically receives status data 124 from operating apparatus 122, and may be configured to persistently store all status data 124, i.e., serve as a repository of all historical status data, received by control system processor 122 from operating apparatus 120. Moreover, in some implementations, as shown in FIG. 1, data acquisition module 102 may also dynamically receive control data 126 provided to operating apparatus 120 by control system processor 122. Also shown in FIG. 1 is proxy processor 104 communicatively coupled to data acquisition module 102, and proxy output data 106 generated by proxy processor 104 based on status data 124 obtained by proxy processor 104 from data acquisition module 102.

Operating Apparatus 120 may take a variety of different forms, depending on the specific implementation of system 100. System 100 may be part of a baggage claim carousel, an automated warehouse, a theme park attraction, a vehicle assembly line machine, or an aviation system, to name merely a few.

Control system processor 122 may include one or more hardware processing units or may be implemented using one or more hardware processing units in combination with software. Examples of suitable hardware processing units include central processing units, graphics processing units, and tensor processing units, field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving software, while a GPU may be implemented to reduce the processing overhead of the CPU by performing computationally intensive graphics or other processing tasks. A TPU is an application-specific integrated circuit (ASIC) configured specifically for artificial intelligence (AI) applications such as machine learning modeling.

In some implementations, control system processor 122 may comprise a general purpose industrial control system, such as a programmable logic controller (PLC), for example. In those implementations, control system processor 122 may be or include a conventional PLC such as one offered commercially by manufacturers such as Rockwell Automation®, Siemens®, Mitsubishi®, Pilz®, Square D®, and ABB Ltd.®, to name a few examples.

Data acquisition module 102 may take the form of any computer-readable non-transitory storage medium. The expression “computer-readable non-transitory storage medium,” as defined in the present application, refers to any medium, excluding a carrier wave or other transitory signal that provides status data 124 to proxy processor 104. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs, RAM, programmable read-only memory (PROM), erasable PROM (EPROM), and FLASH memory.

Moreover, in some implementations, system 100 may utilize a decentralized secure digital ledger in addition to data acquisition module 102. Examples of such decentralized secure digital ledgers may include a blockchain, hashgraph, directed acyclic graph (DAG), and Holochain® ledger, to name a few. In use cases in which the decentralized secure digital ledger is a blockchain ledger, it may be advantageous or desirable for the decentralized secure digital ledger to utilize a consensus mechanism having a proof-of-stake (PoS) protocol, rather than the more energy intensive proof-of-work (PoW) protocol.

In various use cases, proxy processor 104 may be a virtual processor implemented in software, may include a combination of hardware and software elements, or may be implemented as one or more hardware processors. It is noted that proxy processor 104 is configured to mimic, using status data 124 output by operating apparatus 120 and obtained from data acquisition module 102, the operational state of control system processor 122. Consequently, in some implementations, proxy processor 104 may be a duplicate of control system processor 122. That is to say, in some implementations, control system processor 122 and proxy processor 104 may be substantially identical devices, such as the same model PLC or other hardware processing system produced by the same manufacturer, for example.

It is noted that, in some implementations, proxy processor 104 receives and processes status data 124 contemporaneously with the reception and processing of status data 124 by control system processor 122, at the same processing speed. In those implementations proxy processor 104 may process status data 124 in synchronization with the processing of status data 124 by control system processor 122 and may be used to monitor the real-time operational state of control system processor. However, in other use cases, it may be advantageous or desirable for proxy processor 104 to process status data 124 asynchronously with the processing of status data 124 by control system processor 122. In some of those latter use cases, and when proxy processor 104 is implemented in software, proxy processor 104 may be configured to process status data 124 at a processing speed that is faster, or slower, than the processing speed of control system processor 122 when processing status data 124.

It is further noted that in implementations in which data acquisition module 102 stores all status data 124 received by control system processor 122 from operating apparatus 120, proxy processor 104 may be used advantageously to assess a historical operational state of control system processor 122, as part of a forensic analysis of one or more of control system processor 122 or operating apparatus 120 for example. It is also noted that although FIG. 1 depicts system 100 as including a single proxy processor 104, that representation is merely exemplary. In some implementations, system 100 may include multiple proxy processors corresponding to proxy processor 104, each running a different software version, for example, and each obtaining status data 124 from data acquisition module 102.

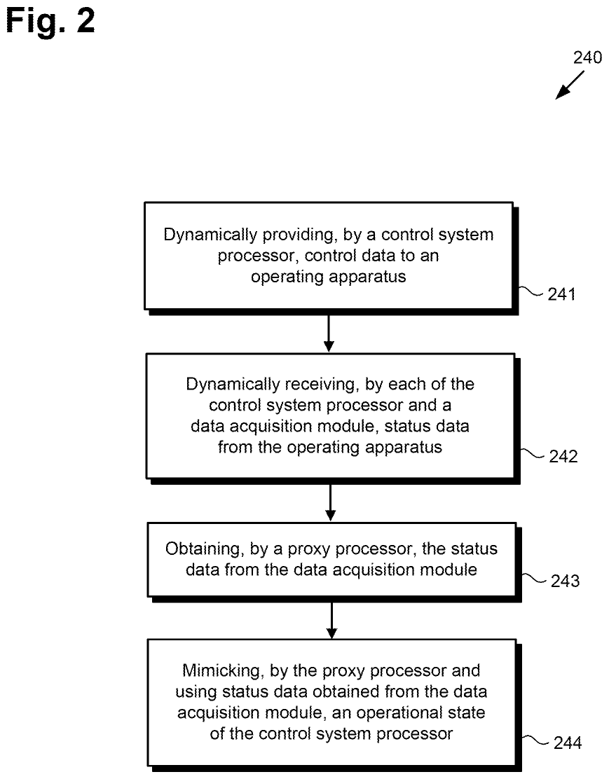

The functionality of system 100 will be further described by reference to FIG. 2 showing flowchart 240 presenting an exemplary method for performing proxy processor based monitoring of control system processor operational state, according to one implementation. With respect to the method outlined in FIG. 2, it is noted that certain details and features have been left out of flowchart 240 in order not to obscure the discussion of the inventive features in the present application.

Referring to FIG. 2, with further reference to FIG. 1, flowchart 240 includes dynamically providing, by control system processor 122, control data 126 to operating apparatus 120 (action 241). As noted above, in various use cases, system 100 may be included in a baggage claim carousel, an automated warehouse, a theme park attraction, a vehicle assembly line machine, or an aviation system, for instance. Examples of control data 126 may include activation of a light on a console, a motor run command, a motor speed command, a motor stop or braking command, and a track switching command, to name merely a few. As noted above, action 241 is performed by control system processor 122 of system 100.

Continuing to refer to FIGS. 1 and 2 in combination, flowchart 240 further includes dynamically receiving, by each of control system processor 122 and data acquisition module 102, status data 124 from operating apparatus 120 (action 242). Examples of status data 124 may include data indicating depression of a button on a console, position sensor data, location sensor data, motion sensor data, brake position data, track position data, and activation of an intrusion system, again to name merely a few. Dynamically receiving status data 124 from operating apparatus 120, in action 242, may be performed contemporaneously by control system processor 122 and data acquisition module 102 of system 100.

It is noted that although flowchart 240 depicts action 242 as following action 241, that representation is merely provided by way of example. In various implementations, action 242 may precede action 241, may follow action 241, or may be performed in parallel with, i.e., contemporaneously with, action 241.

Continuing to refer to FIGS. 1 and 2 in combination, flowchart 240 further includes obtaining, by proxy processor 104, status data 124 from data acquisition module 102 (action 243). As noted above, in some implementations, proxy processor 104 may receive or obtain status data 124 received by data acquisition module 102 from operating apparatus 120 synchronously with receipt of status data 124 by control system processor 122 from operating apparatus 120. That is to say, in some implementations, action 243 may be performed in parallel with action 242.

Continuing to refer to FIGS. 1 and 2 in combination, flowchart 240 further includes mimicking, by proxy processor 104 and using status data 124 obtained from data acquisition module 102, the operational state of control system processor 122 (action 244). The mimicking of the operational state of control system processor 122, by proxy processor 104 using status data 124, results in generation of proxy output data 106, which, when proxy processor 104 accurately mimics control system processor 122, substantially matches or is identical to control data 126 output by control system processor 122. Thus, the operational state of control system processor 122 may be described by proxy output data 106, and may include such parameters as timer values, counter values, or internal bits of control system processor 122, as well as what mode control system processor 122 is presently in.

It is noted that in many industrial applications, the manufacturer of control system processor 122 may provide a development tool that enables access to control system processor 122 and the reading of operational state values of control system processor 122. However, such development tools may not be purely passive, and using such a development tool to directly read out operational values from control system processor 122 may risk inadvertently changing the operational state of control system processor 122 or shutting control system processor 122 down. Thus, the method outlined by flowchart 240 advantageously enables monitoring of the operational state of control system processor 122, indirectly and in real-time, using proxy processor 104 configured to mimic the operational state of control system processor 122, while isolating control system processor 122 from direct testing.

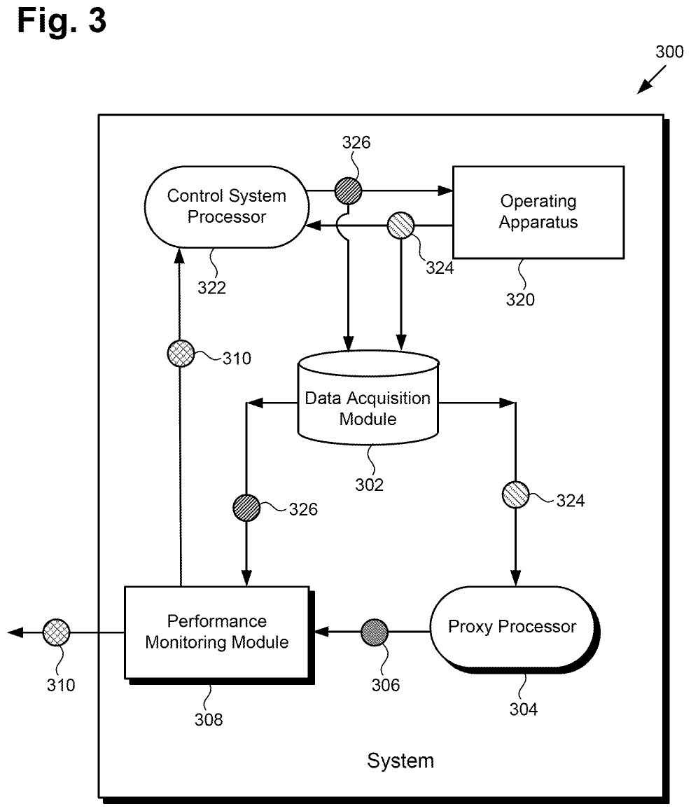

FIG. 3 shows exemplary system 300 for performing proxy processor based monitoring of control system processor operational state, according to another implementation. System 300 includes operating apparatus 320 and control system processor 322 controlling operating apparatus 320 by dynamically providing control data 326 to operating apparatus 320. It is noted that control system processor 322 also dynamically receives status data 324 from operating apparatus 320.

As shown in FIG. 3, system 300 further includes data acquisition module 302 implemented as a non-transitory storage medium. According to the present exemplary implementation, data acquisition module 302 also dynamically receives status data 324 from operating apparatus 322, and may be configured to persistently store all status data 324, i.e., serve as a repository of all historical status data, received by control system processor 322 from operating apparatus 320. Moreover, in some implementations, as shown in FIG. 3, data acquisition module 302 may also dynamically receive control data 326 provided to operating apparatus 320 by control system processor 322.

Also shown in FIG. 3 is proxy processor 304 communicatively coupled to data acquisition module 302, and performance monitoring module 308 communicatively coupled to data acquisition module 302 and proxy processor 304. In addition, FIG. 3 shows proxy output data 306 generated by proxy processor 304 based on status data 324 obtained by proxy processor 304 from data acquisition module 302, and monitoring output 310 generated by performance monitoring module 308 based on comparison of proxy output data 306 to control data 326.

Operating apparatus 320, control system processor 322, control data 326 and status data 324 correspond respectively in general to operating apparatus 120, control system processor 122, control data 126 and status data 124, in FIG. 1. Consequently, operating apparatus 320, control system processor 322, control data 326 and status data 324 may share any of the characteristics attributed to respective operating apparatus 120, control system processor 122, control data 126 and status data 124 by the present disclosure, and vice versa. Thus, like control system processor 122, the operational state of control system processor 322 is defined in accordance with status data 324 received from operating apparatus 320.

In addition, data acquisition module 302, proxy processor 304 and proxy output data 306, in FIG. 3, correspond respectively in general to data acquisition module 102, proxy processor 104 and proxy output data 106, in FIG. 1. That is to say, data acquisition module 302, proxy processor 304 and proxy output data 306 may share any of the characteristics attributed to respective data acquisition module 102, proxy processor 104 and proxy output data 106 by the present disclosure, and vice versa.

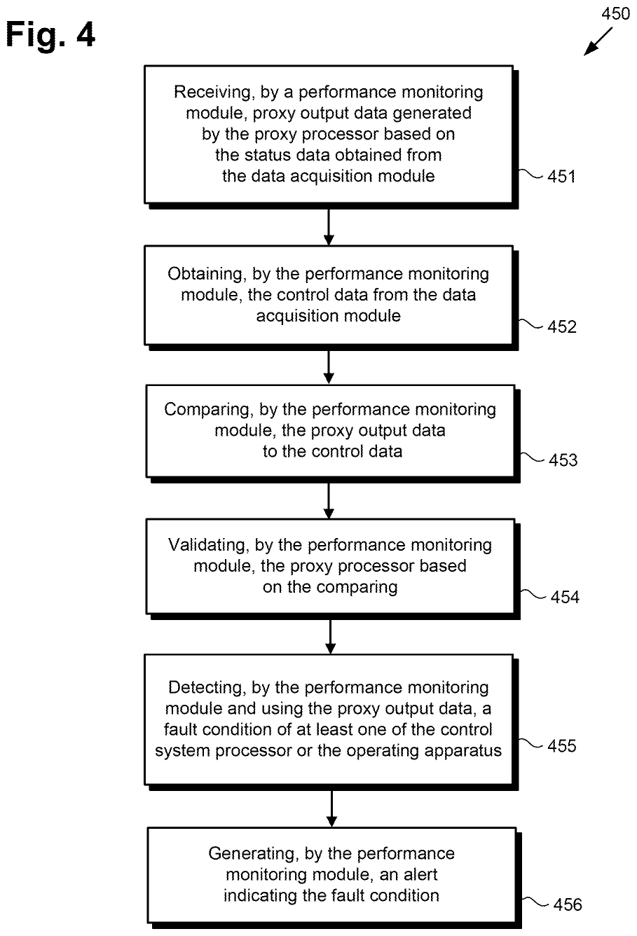

The functionality of system 300 including performance monitoring module 308 will be further described by reference to FIG. 4 showing flowchart 450 describing additional actions for extending the method presented by the flowchart in FIG. 2, according to one implementation. With respect to the actions described in FIG. 4, it is noted that certain details and features have been left out of flowchart 450 in order not to obscure the discussion of the inventive features in the present application. It is further noted that system 300 is configured to execute all of the actions described by flowchart 240, in FIG. 4, and subsequent to execution of those actions may continue to perform the actions described below by reference to flowchart 450.

Referring to FIG. 4 in combination with FIG. 3, flowchart 450 includes receiving, by performance monitoring module 308, proxy output data 306 generated by proxy processor 304 based on status data 324 obtained from data acquisition module 302 (action 451). As noted above, the mimicking of the operational state of control system processor 322, by proxy processor 304 using status data 324 in action 244 described above, results in generation of proxy output data 306, which, when proxy processor 304 is in synchronization with and accurately mimics control system processor 322, substantially matches or is identical to control data 326 output by control system processor 322. Thus, the operational state of control system processor 322 may be described by proxy output data 306, and may include such parameters as timer values, counter values, or internal bits of control system processor 322, as well as what mode control system processor 322 is presently in.

Continuing to refer to FIGS. 3 and 4 in combination, flowchart 450 further includes obtaining, by performance monitoring module 308, control data 326 from data acquisition module 302 (action 452). As shown by FIG. 4, flowchart 450 further includes comparing, by performance monitoring module 308, proxy output data 306 to control data 326 (action 453).

Continuing to refer to FIGS. 3 and 4 in combination, when the comparing performed in action 453 reveals that proxy output data 306 generated by proxy processor 304 based on status data 324 matches control data 326 generated by control system processor 322 based on status data 324, flowchart 450 further includes validating proxy processor 304 (action 454). Validation of proxy processor 304 in action 454 may be reported as monitoring output 310 generated by performance monitoring module 308.

Alternatively, when the comparing performed in action 453 reveals a discrepancy between proxy output data 306 and control data 326, flowchart 450 further includes detecting, by performance monitoring module 308 and using proxy output data 306, a fault condition in one or more of control system processor 322 and operating apparatus 320 (action 455). Moreover, when such a fault condition is detected in action 455, flowchart 450 further includes generating monitoring output 310 in the form of an alert indicating the fault condition (action 456). Such an alert may be transmitted by system 300 to a control systems engineer responsible for one or both of operating apparatus 120 and control system processor 122, for example.

Although in some implementations, simply providing an alert in action 456 may be insufficient to the gravity of the fault condition detected in action (456). Thus, in use cases in which the detected fault condition is identified by performance monitoring module 308 as indicative of a system failure or raises a safety concern, performance monitoring module 308 may generate monitoring output 310 in the form of a command to control system processor 322 to halt or slow the operation of operating apparatus 320 until the fault condition can be further investigated and resolved.

With respect to the method outlined by flowchart 240 in FIG. 2, as well as the additional actions described by flowchart 450 in FIG. 4, it is emphasized that actions 241, 242, 243 and 244 (hereinafter “action 241-244”), or actions 241-244, actions 451, 452 and 453 (hereinafter actions 451-453”) and action 454, or actions 241-244, 451-453, 455 and 456, may be performed in an automated process from which human participation may be omitted.

Thus, the present application discloses systems and methods for performing proxy processor based monitoring of control system processor operational state. The systems and methods disclosed herein advance the state-of-the-art by enabling monitoring of the operational state of a control system processor, indirectly and in real-time, using a proxy processor configured to mimic the operational state of the control system processor, while isolating the control system processor from direct testing.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
an operating apparatus;
a control system processor configured to control the operating apparatus by dynamically providing control data to the operating apparatus, the control system processor further configured to dynamically receive status data from the operating apparatus, wherein an operational state of the control system processor is defined in accordance with the status data received from the operating apparatus;
a data acquisition module configured to also dynamically receive the status data from the operating apparatus; and
a proxy processor communicatively coupled to the data acquisition module, and configured to:
obtain the status data from the data acquisition module; and
mimic, using the status data obtained from the data acquisition module, the operational state of the control system processor.

2. The system of claim 1, wherein the proxy processor is a duplicate of the control system processor.

3. The system of claim 1, wherein the proxy processor is a virtual processor implemented in software.

4. The system of claim 1, wherein the data acquisition module is configured to persistently store all of the status data received by the control system processor from the operating apparatus.

5. The system of claim 1, wherein the data acquisition module is further configured to receive the control data provided to the operating apparatus by the control system processor.

6. The system of claim 5, further comprising:
a performance monitoring module communicatively coupled to the data acquisition module and the proxy processor, the performance monitoring module configured to:
receive proxy output data generated by the proxy processor based on the status data obtained from the data acquisition module;
obtain the control data from the data acquisition module;
compare the proxy output data to the control data; and
validate the proxy processor based on the comparing.

7. The system of claim 6, wherein the performance monitoring module is further configured to:
detect, using the proxy output data, a fault condition of at least one of the control system processor or the operating apparatus; and
generate an alert indicating the fault condition.

8. The system of claim 1, wherein the proxy processor is configured to:
process the status data contemporaneously with processing of the status data by the control system processor, at a same processing speed.

9. The system of claim 1, wherein the proxy processor is configured to:
process the status data at a processing speed that is one of faster or slower than a processing speed of the control system processor.

10. The system of claim 1, wherein the control system processor comprises a programmable logic controller (PLC).

11. The system of claim 1, wherein the system is part of one of a baggage claim carousel, an automated warehouse, a theme park attraction, a vehicle assembly line machine, or an aviation system.

12. A method for use by a system including an operating apparatus, a control system processor configured to control the operating apparatus and having an operational state defined in accordance with status data received from the operating apparatus, a data acquisition module, and a proxy processor communicatively coupled to the data acquisition module, the method comprising:
dynamically providing, by the control system processor, control data to the operating apparatus;
dynamically receiving, by each of the control system processor and the data acquisition module, the status data from the operating apparatus;
obtaining, by the proxy processor, the status data from the data acquisition module; and
mimicking, by the proxy processor using the status data obtained from the data acquisition module, the operational state of the control system processor.

13. The method of claim 12, wherein the proxy processor is a duplicate of the control system processor.

14. The method of claim 12, wherein the proxy processor is a virtual processor implemented in software.

15. The method of claim 12, further comprising:
persistently storing, by the data acquisition module, all of the status data received by the control system processor from the operating apparatus.

16. The method of claim 12, further comprising:
receiving, by the data acquisition module, the control data provided to the operating apparatus by the control system processor.

17. The method of claim 16, wherein the system further comprises a performance monitoring module communicatively coupled to the data acquisition module and the proxy processor, the method further comprising:
receiving, by the performance monitoring module, proxy output data generated by the proxy processor based on the status data obtained from the data acquisition module;
obtaining, by the performance monitoring module, the control data from the data acquisition module;
comparing, by the performance monitoring module, the proxy output data to the control data; and
validating, by the performance monitoring module, the proxy processor based on the comparing.

18. The method of claim 17, further comprising:
detecting, by the performance monitoring module and using the proxy output data, a fault condition of at least one of the control system processor or the operating apparatus; and
generating, by the performance monitoring module, an alert indicating the fault condition.

19. The method of claim 12, wherein the control system processor comprises a programmable logic controller (PLC).

20. The method of claim 12, wherein the system is part of one of a baggage claim carousel, an automated warehouse, a theme park attraction, a vehicle assembly line machine, or an aviation system.
